(19) United States
(12) Patent Application Publication
(10) Pub. No.: US 2025/0085694 A1
(43) Pub. Date: Mar. 13, 2025

(54) SYSTEM AND METHOD FOR ROBOTIC ASSISTED DIE SURFACE FINISHING

(71) Applicant: Ford Global Technologies, LLC, Dearborn, MI (US)

(72) Inventors: Raj Sohmshetty, Canton, MI (US); Chris Schultz, Milford, MI (US); Elizabeth Bullard, Royal Oak, MI (US); Jeff Tornabene, Canton, MI (US); Ramesh Parameswaran, Farmington Hills, MI (US); Kyle Saul, Royal Oak, MI (US); Lorne Forsythe, Wind Lake, WI (US)

(73) Assignee: Ford Global Technologies, LLC, Dearborn, MI (US)

(21) Appl. No.: 18/463,023

(22) Filed: Sep. 7, 2023

(51) Int. Cl. G05B 19/4155

(52) U.S. Cl. CPC G05B 19/4155; G05B 2219/31368

(57) ABSTRACT

A method of performing a finishing operation on a surface of a component includes: (a) generating an image of the surface of the component; (b) comparing the image of the surface of the component with a Computer-Aided Design (CAD) model of the surface of the component to identify a target area to be finished; (c) selecting, by a controller, one of a plurality of finishing tools to perform the finishing operation on the target area; (d) operating, by a robot, a selected one of the plurality of finishing tools to perform the finishing operation; (e) measuring a surface roughness of the target area; and (f) repeating steps (a) to (e) until the surface roughness of the target area satisfies a predetermined value.

### CROSS-REFERENCE TO RELATED APPLICATION

This application is related to a co-pending application titled “Augmented Reality (AR) Assisted Die Making System,” concurrently filed herewith, the content of which is incorporated herein by reference in its entirety.

### FIELD

The present disclosure relates generally to industrial automation systems, and more particularly to vision-based autonomous robot tooling system.

### BACKGROUND

The statements in this section merely provide background information related to the present disclosure and may not constitute prior art.

In the die manufacturing process, finishing a die surface is the final step and typically performed by hands using honing stone and/or sandpaper. Manual polishing is time consuming, and the finishing results may not be consistent depending on personal experience and crafting skills of each worker. Moreover, the surface roughness of the manually polished dies may not always satisfy the surface roughness requirement.

The issues relating to finishing a die surface by hands are addressed in the present disclosure.

### SUMMARY

This section provides a general summary of the disclosure and is not a comprehensive disclosure of its full scope or all of its features.

In one form, a method of performing a finishing operation on a surface of a component is provided. The method includes: (a) generating an image of the surface of the component; (b) comparing the image of the surface of the component with a Computer-Aided Design (CAD) model of the surface of the component to identify a target area to be finished; (c) selecting, by a controller, one of a plurality of finishing tools to perform the finishing operation on the target area; (d) operating, by a robot, a selected one of the plurality of finishing tools to perform the finishing operation; (e) measuring a surface roughness of the target area; and (f) repeating steps (a) to (e) until the surface roughness of the target area satisfies a predetermined value.

In other features, the finishing operation by the selected one of the tools is performed based on operating parameters pre-stored in a memory of the controller and associated with the selected one of the plurality of finishing tools.

In still other features, the method further includes: measuring a contact pressure between the selected one of the finishing tools and the surface of the component and adjusting the operating parameters when the contact pressure exceeds a threshold; scanning the surface of the component; generating the image of the surface of the component based on scanned data and/or generating a surface finish map in real time during the finishing operation; and comparing the surface finish map and the CAD model to determine whether the finishing operation is complete; processing a voice input from an operator and controlling the robot according to the voice input; monitoring the finishing operation by measuring a contact pressure between the selected one of the plurality of tools and the component and/or a current draw of the selected one of the finishing tools; moving, by an autonomous navigation platform on which the robot is mounted, to move the robot around the component.

In still other features, the target area is determined when a difference in geometry between the CAD model and the image of the surface of the component exceeds a threshold.

In another form, a method of performing a finishing operation on a surface of a component is provided. The method includes: generating an image of the surface of the component; comparing the image of the surface of the component with a Computer-Aided Design (CAD) model of the surface of the component to identify a target area to be finished; selecting, by a controller, one of a plurality of finishing tools to perform the finishing operation on the target area; operating, by a robot, a selected one of the plurality of finishing tools to perform the finishing operation; processing, by the controller, a voice input from an operator; and adjusting, by the controller, the finishing operation based on the voice input.

In other features, the method further includes: pre-storing operating parameters corresponding to a plurality of finishing tools in a memory and operating the robot based on the operating parameters corresponding to the selected one of the tools for a particular finishing operation. The controller is configured to include an artificial intelligence (AI) enabled program that iteratively evaluates and adjusts the operating parameters based on voice input from an operator, data relating to geometry of the surface of the component, and measured surface roughness of the target area.

In still another form, a system for performing a finishing operation on a surface of a component is provided. The system includes an autonomous navigation platform, a robot mounted on the autonomous navigation platform, a vision system configured to acquire an image of the surface of the component, a tooling system including a plurality of finishing tools for a plurality of finishing operations, and a controller. The controller is configured to: compare the image of the surface of the component with a computer-aided design (CAD) model of the surface of the component; identify a target area based on a comparison between the CAD model and the image; and select one of a plurality of finishing tools to perform a selected one of the finishing operations.

The controller includes a memory in which a plurality sets of operating parameters corresponding the plurality of finishing operations are stored. The robot is configured to operate the selected one of the tools to perform the selected one of the finishing operations based on one set of the operating parameters corresponding to the selected one of the finishing operations. The system further includes a voice input device, wherein the controller is configured to process a voice input from the operator through the voice input device and is configured to operate the selected one of the finishing tools based on the voice input.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram of a finishing system constructed in accordance with the teachings of the present disclosure;

FIG. 2 is a schematic diagram of a main controller of the finishing system constructed in accordance with the teachings of the present disclosure; and

FIG. 3 is a flow diagram of a method of performing a finishing operation on a die surface in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

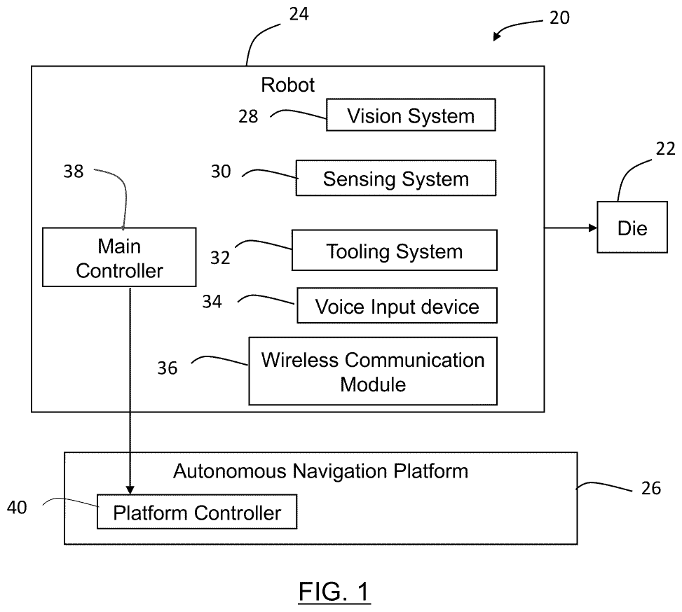

Referring to FIG. 1, a finishing system 20 for performing a finishing operation on a surface of a die 22 constructed in accordance with the teachings of the present disclosure includes a robot 24 and an autonomous navigation platform 26 on which the robot 24 is mounted for moving the robot 24 around the die 22. The robot 24 includes a vision system 28, a sensing system 30, a tooling system 32, a voice input device 34, a wireless communication module 36 (i.e., communication link), and a main controller 38 configured to control the operation of the various systems/devices/components of the robot 24, as well as the autonomous navigation platform 26.

The autonomous navigation platform 26 (hereinafter “platform”) may be an autonomous mobile robot (AMR) and includes a platform controller 40 for controlling the various components/devices (not shown) of the platform 26. The platform controller 40 is in communication with the main controller 38 and is configured to control the movement of the platform 26 in response to the data received from the main controller 38.

The robot 24 may be a collaborative robot (i.e., “Cobot”), which can operate alongside humans in a shared workspace. The robot 24 is configured to autonomously move to various locations around the die 22 such that the end effectors of the tooling system 32 can perform a desired finishing operation on a target area of the die surface to be finished. The main controller 38 may be an on-board controller to provide the required computing and data processing. Alternatively, the main controller 38 may have some parts installed in the robot 24 and another parts provided in an external device or in the Cloud and communicated with the on-board controller by the wireless communication module 36. The main controller 38 is configured to control operation of the various components mounted on the robot 24 and the movement of the platform 26 through the platform controller 40 to partially or fully autonomously perform the finishing operation on the die surface. The control by the main controller 38 may be based on pre-stored data in the main controller 38, data obtained from the vision system 28 and data obtained from the sensing system 30 and/or voice inputs from an operator. It is understood that while the finishing system 20 is described to perform a finishing operation on a die 22, the finishing system 20 can be used to perform a finishing operation on surface of a component which is not a die, or to perform another surface treatment operation on a surface of a component or die without departing from the scope of the present disclosure. For example, the finishing system can be used, without or with slight modification, to perform other surface treating operation, such as electropolishing and chemical etching or shot blasting.

The vision system 28 includes one or more cameras, such as a two-dimensional (2D) camera, a three-dimensional (3D) camera, a stereo vision camera, an infrared sensor, a radar scanner, a Stereo/RGB-D scanner, an optical scanner, a laser scanner, a blue light scanner, a light detection and ranging (LIDAR) sensor, and/or an ultrasonic sensor. The vision system 28 is configured to scan the surface of the die 22 and acquire an image of the die surface based on the scanned data. The image of the die surface shows the global geometry of the die surface. The vision system 28 may also include an object detection device, such as an optical or laser micrometers, configured to detect obstacles on or around the robot. The vision system 28 is also configured to identify a target area that needs to be finished and surface normal that do not need to be finished.

The sensing system 30 includes a plurality of sensors for measuring contact pressure between the finishing tools and the die surface, a contour/geometry of the die surface, and surface roughness of the die, particularly the surface roughness of the target area. The sensing system 30 may include laser or LIDAR profilometers for obtaining surface roughness of the die surface, and for obtaining measurements of local geometry of an area of the die surface (such as radius of a male portion or a radius of a female portion on the die surface, contour and geometry of the target areas). The sensing system 30 may include a pressure sensor in the form of a touch probe to monitor the contact pressure between the die surface and the finishing tool during the finishing operation. The sensors of the sensing system 30 may be installed on the robot 24, or some or all of the sensing system 30 may be infrastructure-based sensing for navigation and operation. The sensors of the sensing system 30 may be used to obtain precise measurements of local areas of the die surface, whereas the vision system 28 may be used to obtain global geometry of the die surface to save time.

The data acquired by the vision system 28 and the sensing system 30 may be transmitted to the main controller 38 via the wireless communication module 36 for further processing and comparison.

The tooling system 32 includes a plurality of interchangeable end effectors including a plurality of finishing tools. The plurality of finishing tools are operated to perform different types and grades of finishing operations including but not limited to grinding (for rough finishing), stoning (for Class A surface finishing), honing, polishing, buffing, sandblasting. The plurality of finishing tools may include grinding wheels, sand papers, honing stones, sanders and polishers having different grits for different grades of finish. The sand papers and the honing stones may be dry for rough finishing or immersed in oil for final finishing. Honing stones are generally used for Class A surface finishing. The finishing tools may also include a non-abrasive pad for removing dirt when the die surface is coated with a protective coating such as chrome.

The voice input device 34 may include a microphone and is configured to receive voice commands from an operator.

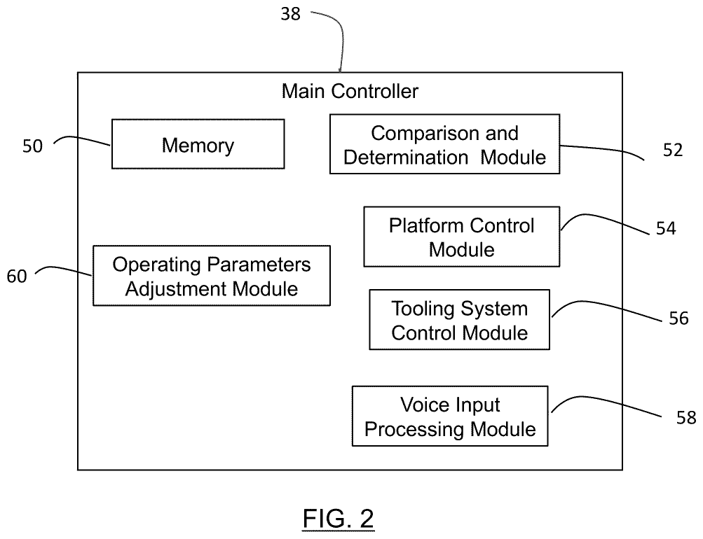

Referring to FIG. 2, the main controller 38 includes various modules/devices to control and monitor the finishing operations performed by the robot 24 on the die surface. The main controller 38 includes a memory 50, a comparison and determination module 52, a platform control module 54, a tooling system control module 56, a voice input processing module 58, and an operating parameters adjustment module 60. It is understood that one or more of these modules may be positioned at the same location or distributed at different locations and communicably coupled accordingly. In one form, the modules of the main controller 38 are communicably coupled using a wired and/or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

The memory 50 is configured to store data required for the finishing operations on the die 22. The data stored in the memory 50 may include, but be not limited to, CAD models of surfaces of various dies with target measurements and target surface roughness, a central tool library that map different types of finishing operations to a plurality of finishing tools, and a plurality sets of operating parameters corresponding the plurality of finishing operations and finishing tools. For example, one die from among the plurality of dies may require a Class A, whereas another die from among the plurality of dies 22 may require a Class B surface. A Class A surface is a visual surface with aesthetic look and has a curvature continuity without any features like ribs, snaps, bosses etc., and thus requires higher smoothness of the surface. A Class B surface refers to an invisible surface that may have features like rib, boss, snap etc. and has tangent continuity and thus has relatively large surface roughness. In addition, the CAD models for different dies may be classified as a Class A component (outer part) or a Class B component (inner part). The CAD models can also identify features as male or female parts, where only male features require better surface finish.

The comparison and determination module 52 is configured to: receive images from the vision system 28; retrieve a CAD model corresponding to the die 22 from the memory 50; identify one or more target areas to be finished when a difference in the contour or geometry between the CAD image and the image from the vision system 28 exceeds a threshold; and select a desired finishing operation from among a plurality of finishing operations and select a finishing tool from among the plurality of finishing tools to perform the desired finishing operation. After the target area(s) are identified, the data relating to the target area(s) may be transmitted to a control module (not shown) for a fiduciary marker or a physical marker to mark the target areas.

The images of the surface from the vision system 28 show the current measurements of the die surface. The CAD models stored in the memory 50 show the target measurements of the die surface. The comparison and determination module 52 is configured to match key points (such as male parts or female parts) with the CAD geometry to auto-calibrate before the comparison. Based on the comparison, the target areas to be finished and the amount of material to be removed can be determined. The target areas may be marked by different color code depth indicating the amount of material to be removed. Alternatively, the robot 24 may use a blue die ruler to check the surface level and identify the area where more polishing is needed. The comparison and determination module 52 can also extract radii in critical regions using CAD or the scanned image. if the radii are smaller than certain value, the region requires better finish.

The platform control module 54 is configured to, after the target areas are identified, determine the desired movement of the robot 24 and then transmit data to the platform controller 40 of the platform 26, which in turns controls the movement of the platform 26 around the die 22 to a location proximate the one of the target areas.

The tooling system control module 56 is configured to perform a trained finishing operation by operating the selected finishing tool from among the plurality of finishing tools based on the determination by the comparison and determination module 52 and based on the operating parameters stored in the memory 50 and corresponding to the selected finishing tool. The operating parameters stored in the memory 50 may be pre-stored before the start of the finishing operation and may be updated by the operating parameters adjustment module 60 during and after the finishing operation, taking into account the actual conditions of the finishing operation.

The voice input processing module 58 is configured to process the voice commands from an operator through the voice input device 34, such as a microphone. For example, the voice commands from the operator may be “polish the area in the red box using stone X or sandpaper Y”, “stop,” “move left,” “move right,” “move back,” “polish lighter” and “polish harder.” An operator may work alongside the robot 24 and draw a box around an area that needs to be finished by using a marker to help the main controller 38 identify a target area to be finished and to assist in training of the main controller 38.

After the voice command from the operator is processed, the voice input processing module 58 is configured to send data associated with these voice inputs to another one or more modules of the main controller 38 to execute the voice commands. For example, the voice input processing module 58 may send data relating to the voice command to the platform control module 54 to move the robot around the die 22. The voice input processing module 58 may send data relating to the voice command to the tooling system control module 56 to adjust the operation of the finishing tool, such as adjusting the angle, height, speed of the finishing tool. The voice input processing module 58 may include a program (such as ChatGPT), which is trained to follow and interpret the voice commands from the operator and interact with the operator. By using the voice command, the main controller 38 can control the finishing tool and can be better trained with the assistance of the operator based on the operator's experience and/or data shown on a control panel (not shown) of the finishing system 20.

The operating parameters adjustment module 60 is configured to adjust the operating parameters corresponding to the plurality of finishing operations based on the data from the vision system 28, the sensing system 30 and data from the voice input processing module 58. The operating parameters for a particular finishing tool for a particular finishing operation may be set based on ideal conditions of the finishing operations and may not achieve an optimum result in actual conditions. The operating parameter adjustment module 60 may include an AI-based program which can be trained by the data from the vision system 28, the sensing system 30, and the voice input processing module 58 to learn to adjust the operating parameters to achieve a better finishing result.

For example, during the finishing operation, the selected finishing tool may not maintain a predetermined contact pressure with the die surface to perform the desired finishing operation. The contact pressure between the die surface and the selected finishing tool may be constantly monitored during the finishing operation and the data relating to the contact pressure may be sent to the operating parameters adjustment module 60 as feedback. The contact pressure may be determined based on the measurements by a pressure sensor of the sensing system 30 or based on the current draw of the selected finishing tool.

Moreover, the vision system 28 scans the die surface and obtains a real-time finishing map and the sensing system 30 obtains real time measurements of the surface roughness and/or geometry of the die surface. The real-time finishing map is compared with the map/image from the previous step or the CAD model. The measurements of the surface roughness by the sensors also help the comparison and determination module 52 determine whether the finishing operation is complete or whether another finishing tool should be used to perform a different finishing operation. The data from the vision system 28 and the sensing system 30 are transmitted to the comparison and determination module 52 to update the information about the target areas to be finished, the amount of material to be removed, and the type of finishing operation to be performed and the finishing tool from among a plurality of finishing tools to be used. The data from the vision system 28 and the sensing system 30 may also be transmitted to the operating parameters adjustment module 60 to update the operating parameters. The updated operating parameters are stored in the memory 50. The parameters that affect surface finish include, but are not limited to, the type of the tools (e.g., sandpapers or stones), tool condition (dry or wet), feeds and speeds of the tools, toolpath parameters, cut width, tool deflection, cut depth, vibration, and coolant.

The various modules of the main controller 38 for controlling the robot may include an artificial intelligence (AI) based program and may be trained by the data acquired during the finishing operations to learn to recognize the target areas that need polishing and complete the finishing operation on the target areas without prompting and supervision by an operator.

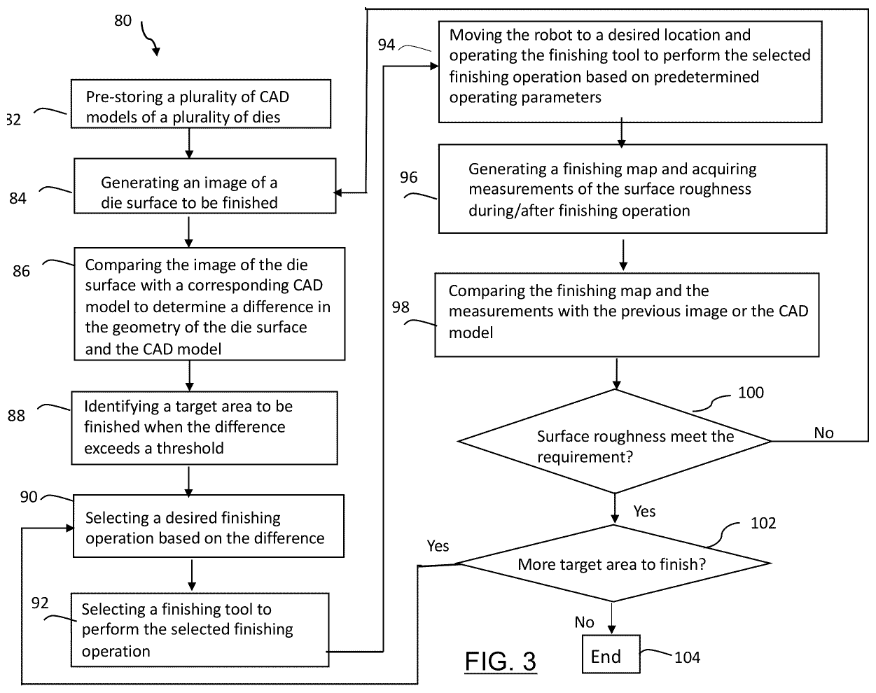

Referring to FIG. 3, a method 80 of performing a finishing operation on a surface of a die starts with pre-storing a plurality of CAD models of a plurality of dies having different dimensions and roughness requirements in step 82. Next, an image of the surface of an incoming die to be finished is generated in step 84. The image may be generated, by a vision system, based on scanned data acquired by blue light or laser scan. The image of the incoming die is compared with a corresponding one of the CAD model to determine a difference in the geometry of the die surface in step 86. The comparison and determination module may overlay the image of the die on the CAD model for this comparison. Then, the comparison and determination module identifies one or more target areas to be finished when the difference in the geometry between the CAD model and the image of the die exceeds a threshold in step 88. The threshold depends on a surface roughness requirement. For example, a Class A surface may have a lower threshold, whereas a Class B surface may have a higher threshold. Based on the difference, the amount of the materials to be removed from the target area is determined and a desired finishing operation is selected in step 90.

Thereafter, one of a plurality of finishing tools is selected to perform the selected finishing operation in step 92. The robot is then moved around the die to a desired location to operate the selected finishing tool to perform the desired finishing operation based on predetermined operating parameters in step 94. The predetermined operation parameters are stored in the memory 50 and correspond to the selected finishing operation. The operating parameters may include the head angle of the finishing tool, the contact pressure, the robot position, and the time to apply.

During and/or after the finishing operation, the vision system 28 generates a finishing map based on updated scanned data and the sensing system 42 acquires real-time updated measurements of the die surface relating to the surface roughness of the target area and the geometry/contour of the die surface in step 96. The finishing map and surface roughness are compared with the previous image of the die surface or the CAD model to determine whether the finishing operation is complete or whether further finishing operation is required in step 98. The main controller determines whether the surface roughness of the target area meet a predetermined value, i.e., within a predetermined range of the target surface roughness in step 100. If the surface roughness of the target area is within the predetermined range of the target surface roughness, the method goes to step 102 to determine whether more target area(s) need to be finished in step 102. If no more target area needs to be finished, the method ends in step 104. If more target area(s) need to be finished, the method goes back to step 90 to select a desired finishing operation for another target area.

On the other hand, if, after the finishing operation by the selected finishing tool, the main controller determines that the surface roughness does not meet the predetermined value in step 100, the method goes back to step 84 to continue to evaluate the condition of the die by generating an image of the die surface and then continue the following steps until the surface roughness of the target area meets the requirement in step 100.

While not shown in FIG. 3, it is understood that the control of the finishing operation can be adjusted or overridden by a voice input from an operator in any step of the method and during training of the robot to help the training and operation of the robot.

The finishing system 20 constructed in accordance with the teachings of the present disclosure can partially or fully autonomously perform the finishing operation on a die surface to reduce human errors. By comparing the image of the die and the pre-stored CAD model of the die, one or more target areas that need to be finished can be identified. In addition, based on this comparison, the amount of materials to be removed from the targets areas can be determined and a desired finishing tool can be selected to perform the desired finishing operation in accordance with pre-stored operating parameters corresponding to the selected finishing tool. Real-time surface scan of the die and measurements of the surface (such as surface roughness and measurement of geometry) on the target areas can be obtained to provide information about the status of the finishing operation, i.e., whether the measurements meet the specifications (and the finishing operation is complete) or whether another finishing tool is needed for another finishing operation. This information can also be used to update the operating parameters to optimize a next or future finishing operation. The profilometers may be used to measure only the surface roughness and geometry of the target area(s), rather than the entire die surface to save time. A human operator can work alongside the finishing system 20 to facilitate and help training and operation of the robot.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of performing a finishing operation on a surface of a component, the method comprising:
(a) generating an image of the surface of the component;
(b) comparing the image of the surface of the component with a Computer-Aided Design (CAD) model of the surface of the component to identify a target area to be finished;
(c) selecting, by a controller, one of a plurality of finishing tools to perform the finishing operation on the target area;
(d) operating, by a robot, a selected one of the plurality of finishing tools to perform the finishing operation;
(e) measuring a surface roughness of the target area; and
(f) repeating steps (a) to (e) until the surface roughness of the target area satisfies a predetermined value.

2. The method according to claim 1, wherein the surface roughness of the target area is measured after the finishing operation by the selected one of the plurality of finishing tools is performed.

3. The method according to claim 1, wherein the finishing operation by the selected one of the tools is performed based on operating parameters pre-stored in a memory of the controller and associated with the selected one of the plurality of finishing tools.

4. The method according to claim 1, further comprising measuring a contact pressure between the selected one of the finishing tools and the surface of the component and adjusting the operating parameters when the contact pressure exceeds a threshold.

5. The method according to claim 1, further comprising monitoring the finishing operation by measuring a contact pressure between the selected one of the plurality of tools and the component and/or a current draw of the selected one of the finishing tools.

6. The method according to claim 1, further comprising scanning the surface of the component and generating the image of the surface of the component based on scanned data.

7. The method according to claim 1, further comprising scanning the surface of the component and generating a surface finish map in real time during the finishing operation.

8. The method according to claim 7, further comprising comparing the surface finish map and the CAD model to determine whether the finishing operation is complete.

9. The method according to claim 1, further comprising processing a voice input from an operator and controlling the robot according to the voice input.

10. The method according to claim 1, wherein the controller is configured to include an artificial intelligence (AI) enabled program that iteratively evaluates and adjusts the operating parameters based on voice input from an operator, data relating to geometry of the surface of the component, and measured surface roughness of the target area.

11. The method according to claim 1, further comprising moving, by an autonomous navigation platform on which the robot is mounted, to move the robot around the component.

12. The method according to claim 1, wherein the target area is determined when a difference in geometry between the CAD model and the image of the surface of the component exceeds a threshold.

13. A method of performing a finishing operation on a surface of a component, the method comprising:
generating an image of the surface of the component;
comparing the image of the surface of the component with a Computer-Aided Design (CAD) model of the surface of the component to identify a target area to be finished;
selecting, by a controller, one of a plurality of finishing tools to perform the finishing operation on the target area;
operating, by a robot, a selected one of the plurality of finishing tools to perform the finishing operation;
processing, by the controller, a voice input from an operator; and
adjusting, by the controller, the finishing operation based on the voice input.

14. The method according to claim 13, further comprising: pre-storing operating parameters corresponding to a plurality of finishing tools in a memory and operating the robot based on the operating parameters corresponding to the selected one of the tools for a particular finishing operation.

15. The method according to claim 13, wherein the controller is configured to include an artificial intelligence (AI) enabled program that iteratively evaluates and adjusts the operating parameters based on the voice input from the operator, data relating to geometry of the surface of the component, and measured surface roughness of the target area.

16. A system for performing a finishing operation on a surface of a component, the system comprising:
an autonomous navigation platform;
a robot mounted on the autonomous navigation platform;
a vision system configured to acquire an image of the surface of the component;
a tooling system including a plurality of finishing tools for a plurality of finishing operations;
a controller configured to:
compare the image of the surface of the component with a computer-aided design (CAD) model of the surface of the component;
identify a target area based on a comparison between the CAD model and the image; and
select one of a plurality of finishing tools to perform a selected one of the finishing operations.

17. The system according to claim 16, wherein the controller includes a memory in which a plurality sets of operating parameters corresponding the plurality of finishing operations are stored.

18. The system according to claim 17, wherein the robot is configured to operate the selected one of the tools to perform the selected one of the finishing operations based on one set of the operating parameters corresponding to the selected one of the finishing operations.

19. The system according to claim 16, further comprising a voice input device, wherein the controller is configured to process a voice input from the operator through the voice input device and is configured to operate the selected one of the finishing tools based on the voice input.

20. The system according to claim 16, wherein the controller is configured to control the autonomous navigation platform to move the robot around the component.
